(19) United States
(12) Patent Application Publication
(10) Pub. No.: US 2014/0348988 A1
(43) Pub. Date: Nov. 27, 2014

(54) Method and Device for the Pasteurization and/or Sterilization of a Food

(71) Applicant: Bühler Barth GmbH, Freiberg (DE)

(72) Inventors: Peter Braun, Kreuzlingen (CH); Marco Keller, Bissegg (CH); Rainer Perren, Grosswangen (CH)

(21) Appl. No.: 14/364,635

(22) PCT Filed: Dec. 6, 2012
(86) PCT No.: PCT/EP2012/075224

§ 371 Date: Jun. 11, 2014

(30) Foreign Application Priority Data
Dec. 12, 2011 (EP) 11193032.7

(51) Int. Cl. A23L 3/3418; A23L 3/00; A23L 3/16

(52) U.S. Cl. CPC A23L 3/3418; A23L 3/165; A23L 3/003
USPC 426/233; 426/511; 426/455; 99/468; 99/467

(57) ABSTRACT

The method for pasteurisation and/or sterilisation of a food according to the invention comprises, in a first step, provision of a device (1) for the impingement of steam, particularly water vapour, on a food. The food is then impinged upon with steam for the pasteurisation and/or sterilisation of the food by means of the steam in order to achieve a reduction in the quantity of a microorganism present on and/or in the food, particularly a pathogenic microorganism. Before the food is impinged upon with steam, the temperature of the food is brought to a preheating temperature greater than or equal to the pasteurisation and/or sterilisation temperature.

The invention relates to a method and to an apparatus for the pasteurization and/or sterilization of a foodstuff, as per the preamble of the independent claims.

WO 2009/003545 discloses a method for the roasting and surface pasteurization of particulate foodstuff products. According to the disclosure, the foodstuff is pasteurized in a humid atmosphere, wherein the temperature of the product surface is lower than the temperature of the vapor that is fed in.

A similar method for the surface pasteurization and surface sterilization of particulate foodstuff products is also known from WO 2009/003546 A1. In said disclosure, too, the foodstuff products are preheated, before the pasteurization or sterilization, to a temperature a few degrees below the corresponding pasteurization or sterilization temperature. The pasteurization is carried out at temperatures between 55° C. and 99° C. at a low pasteurization pressure, and the sterilization is carried out at temperatures between 100° C. and 140° C. at a relatively high sterilization pressure.

Said methods which are known from the prior art already reduce the water absorption significantly. For certain foodstuffs, however, the water absorption that occurs during the treatment with said methods is still too high in respect of the modern demands for industrial applications. Said increase in the moisture content of the foodstuff often requires an additional drying step which, under some circumstances, adversely affects the quality of the foodstuff and furthermore results in increased energy consumption.

It is therefore an object of the present invention to eliminate the known disadvantages and, in particular, to provide a method and an apparatus for pasteurization and/or sterilization which minimizes the absorption of moisture during the pasteurization and/or sterilization with vapor. It is also a further object of the present invention to provide a method for pasteurization and/or sterilization with high reproducibility and lower energy consumption.

Said objects are achieved by means of a method and an apparatus according to the independent claims.

The method according to the invention for the pasteurization and/or sterilization of a foodstuff is implemented in particular using a particulate and/or hygroscopic foodstuff. In a first step, the method comprises providing an apparatus for the impingement of vapor, in particular water vapor, on the foodstuff. The apparatus comprises in particular a vessel with an interior space for accommodating the foodstuff and with a device for charging the interior space with vapor. The foodstuff is subsequently impinged on with vapor for the purpose of pasteurizing and/or sterilizing the foodstuff by means of the vapor in order to achieve a reduction in the quantity of a microorganism, in particular a pathogenic microorganism, present on and/or in the foodstuff. Before the foodstuff is impinged on with vapor, the temperature of the foodstuff is adjusted to a preheating temperature which is higher than or equal to the pasteurization and/or sterilization temperature.

In particular, the quantity of a microorganism, in particular a pathogenic microorganism, present on and/or in the foodstuff is reduced at least by a factor of log 3. The quantity of pathogenic microorganism is preferably reduced by a factor of log 4, and particularly preferably by at least a factor of log 5.

In particular, the pasteurization or sterilization temperature corresponds to the evaporation temperature of water at a given pressure. Use is preferably made of saturated steam.

It is preferable for the temperature of the foodstuff to be adjusted to a preheating temperature in the range from 0° C. to 20° C., in particular in the range from greater than 0° C. to 20° C., in particular in the range from 0° C. to 10° C., and in particular from greater than 0° C. to 10° C., above the pasteurization and/or sterilization temperature. It is particularly preferable for the temperature of the foodstuff to be adjusted to a preheating temperature in the range from 0° C. to 8° C., or 9° C. to 20° C., in particular in the range from greater than 0° C. to 8° C., or greater than 9° C. to 20° C., above the pasteurization and/or sterilization temperature.

In particular, the method according to the invention does not encompass a method for the pasteurization of raw almonds, containing the bacterium Enterococcus faecium NRRL-B2354, with a preheating temperature of 90° C. and a pasteurization temperature of 81.5° C.

The method is carried out in particular in batch-wise fashion.

Within the context of the present application, the expression “pasteurization and/or sterilization” refers to a treatment of a foodstuff with vapor at elevated temperature for the purpose of reducing the number of pathogenic microorganisms on and/or in the foodstuff. An “elevated temperature” is to be understood to mean a temperature higher than normal ambient temperature. Normal ambient temperatures lie in the range from 20° C. to 30° C.

Within the context of the present application, “reduction in the quantity of a pathogenic microorganism present on and/or in the foodstuff by a factor of log 3” is to be understood to mean a reduction by a factor of 1000. Analogously, a reduction by a factor of log 4 means a reduction by a factor of 10,000, and a reduction by a factor of log 5 means a reduction by a factor of 100,000.

The determination of the reduction in number may for example be performed in accordance with the guidelines of the Almond Board of California (Guidelines for Process Validation using Enterococcus faecium NRRL B-2354). Furthermore, the determination may be performed, for further microorganisms, in accordance with the following methods: in accordance with ISO 4833 for aerobic mesophilic germs; in accordance with ISO 7932 for Bacillus cereus; in accordance with the Swiss Book of Foodstuffs 2000 (hereinafter referred to as SLMB 2000), chapter 56, E.7 for Clostridium perfringens; in accordance with ISO 16649-2 for Escherichia coli; in accordance with SLMB 2000, chapter 56, E.10 for yeasts and molds; in accordance with the Swiss Book of Foodstuffs 1988 (hereinafter referred to as SLMB 1988), chapter 56 for Lactobacilli; in accordance with ISO 11290-1 for Listeria monocytogenes; in accordance with SLMB 2000, chapter 56, E.4 for Pseudomonas aeruginosa; in accordance with ISO 6888-2 for coagulase positive staphylococci.

Within the context of the present application, the wording “A and/or B” is to be understood to mean that the following combinations are possible and disclosed: A on its own; B on its own; A and B.

A “foodstuff” is to be understood within the context of the present application to mean foodstuffs that are suitable for human consumption, in particular protein-containing foodstuffs, starch-containing foodstuffs and oil-containing foodstuffs or any desired combination of these. In particular, foodstuffs within the context of the present application are granular and/or powder foodstuffs.

Within the context of the present application, starch-containing foodstuffs are to be understood to mean cereals, that is to say cultivated plants from the botanical family of grasses, grain, rice, maize, pseudocereals such as amaranth or quinoa and any desired combinations of these.

Within the context of the present application, “protein-containing foodstuffs” are to be understood to mean pulses such as for example soya, lupines and dried powder products of milk, and any desired combinations of these.

Within the context of the present application, “oil-containing foodstuffs” are to be understood to mean nuts such as for example hazelnuts, almonds, pistachio nuts, cashew nuts, macadamia nuts, walnuts, pecan nuts, Brazil nuts, oilseeds such as sesame seeds, flaxseeds, peanuts, sunflower seeds or seeds from other plants, and any desired combinations of these.

Foodstuffs are for example also to be understood to mean plant parts of herbs and other foodstuffs derived from stalks, leaves, roots, nodules, seeds, buds, blossoms and spices in any desired form, that is to say for example unground or ground.

A “hygroscopic foodstuff” is to be understood within the meaning of the present application to mean water-attracting foodstuffs. Within the context of the present application, a foodstuff is hygroscopic if, when the foodstuff and the gas phase, for example air, surrounding the foodstuff are at a temperature of 25° C., more than 0.14 g of water is required per gram of dry mass in order to increase the water activity a_{w} of the foodstuff by 0.1.

The water activity a_{w} is a dimensionless variable in the range from 0 to 1. The water activity is determined in accordance with ISO 21807:2004(E), preferably in accordance with the method, specified in point 4 a), of direct manometric pressure measurement. Here, a vessel which is closed off with respect to the environment is filled substantially completely with the foodstuff to be measured, and the relative air humidity above the foodstuff is measured, this corresponding to the water activity.

For example, hygroscopic foodstuffs have porous surfaces, in particular with capillaries arranged in the surface and/or hygroscopic components present at least on the surface of the foodstuff. Hygroscopic components are for example sugars, oligosaccharides, maltodextrins, fructooligosaccharides and soluble proteins, and any desired combinations of these.

Within the context of the present application, “vapor” is to be understood to mean a gaseous medium that is produced by evaporation of a liquid. In particular, “vapor” is to be understood to mean water vapor, and preferably saturated steam. Alternatively and/or in addition, the vapor may also have further components such as for example alcohol, ozone, oxidative components and preservative acid, such as for example vinegar, and any desired combinations of these. The vapor may thus comprise evaporated water, evaporated alcohol, ozone, evaporated oxidative components and evaporated preservative acid, and any desired combinations of these.

The method according to the invention has the advantage that, owing to the fact that the temperature of the surface of the foodstuff is adjusted to a preheating temperature higher than or equal to the pasteurization and/or sterilization temperature, it is achieved that less water is absorbed by the foodstuff while, at the same time, pasteurization and/or sterilization takes place. This leads to increased quality of the foodstuff because said foodstuff is subjected to less of a change in taste, appearance, color and texture, for example, as a result of the pasteurization and/or sterilization process. This also has the advantage that a drying step for drying the foodstuff after the treatment process is often no longer necessary, which leads to lower energy consumption and has the effect that the method can be carried out more quickly, which is expedient from a cost aspect.

The method is preferably characterized by the provision of the apparatus comprising a pressure setting apparatus for setting a positive pressure and/or negative pressure and setting the pressure in the interior space. Provision is made in particular for control and/or regulation of the pressure, preferably control and/or regulation of a positive pressure or a negative pressure, in the interior space.

Within the context of the present application, the expression “positive pressure” is to be understood to mean a pressure greater than ambient pressure. In particular, a positive pressure is to be understood to mean a pressure in the range from greater than 1.01 bar to 3.5 bar absolute pressure.

Within the context of the present application, the expression “negative pressure” is to be understood to mean a pressure lower than ambient pressure. In particular, a negative pressure is to be understood to mean a pressure in the range from 0.1 bar to 0.99 bar absolute pressure.

Within the context of the present application, the expression “ambient pressure” is to be understood to mean a standardized pressure of 1.023 bar absolute pressure.

This possibility for setting the pressure in the interior space has the advantage that the required pressure can be set in accordance with the demands on the treatment method. For pasteurization, it is normally necessary for a negative pressure to be set in the interior space, and for sterilization, it is normally necessary for a positive pressure to be set in the interior space. Through the possibility of controlling and/or regulating the pressure, it is advantageously possible for the conditions during the treatment of the foodstuff in the interior space to be correspondingly adapted in order to optimize the result of the treatment.

It is particularly preferable for the foodstuff to be dried, in particular after the pasteurization and/or sterilization. The drying is performed in particular by means of vacuum drying.

This has the advantage that the foodstuff can be prepared for the treatment process, that is to say the pasteurization and/or sterilization, by virtue of a moisture content of the foodstuff being set by way of the drying step. Alternatively or in addition, the foodstuff may be dried after the treatment in order to set a moisture content for example for the storage of the foodstuff or for further processing.

The use of vacuum drying has the advantage that the product substantially does not need to be heated any further for this purpose, and instead, the energy for the water evaporation is substantially extracted from the product, whereby the product is simultaneously cooled. The step of vacuum drying leaves the quality of the foodstuff substantially unchanged. For example, drying with heated air could under some circumstances, in interaction with the moisture in the foodstuff, result in a cooked flavor, which is often undesired.

It is very particularly preferable for the temperature of the surface of the foodstuff to be determined by means of a sensor during the temperature adjustment.

Within the context of the present application, a “sensor” for determining the temperature of the surface of the foodstuff is to be understood to mean a device for the direct and/or indirect determination of the temperature of the surface. For example, the sensor may be configured as a temperature sensor which is in contact with the foodstuff. It is alternatively also possible, for example, for the sensor to be configured as an infrared sensor or as a microwave sensor. Both examples for the configuration of the sensor perform a direct measurement of the temperature of the surface of the foodstuff.

The determination of the temperature of the surface of the foodstuff during the temperature adjustment has the advantage that the corresponding information is available to the operator, and the apparatus can be correspondingly controlled and/or regulated on the basis of the determined temperature. It can be ensured in this way that the pasteurization and/or sterilization is commenced only after the preheating temperature is attained, which leads to better reproducibility of the treatment process. Furthermore, the treatment process can be started as soon as the preheating temperature has been reached, which leads to shorter treatment times.

The temperature of the surface of the foodstuff is preferably determined from the temperature of the gas flowing around the foodstuff, in particular after the product has been conveyed into the vessel, which is in particular in the form of a pressure vessel, that is to say a positive pressure and/or negative pressure can be maintained in the vessel. In particular, the temperature of the water vapor flowing around the foodstuff is determined, in particular after the water vapor has been conveyed out of the vessel. The temperature of the surface of the foodstuff is determined in particular from the temperature of the gas that is extracted from the vessel and/or from a temperature adjustment device by means of a pump.

Gas preferably flows around in such a way that an exchange of heat can take place between the gas, in particular water vapor, and foodstuff, which exchange of heat is such that the gas conveyed out of the vessel is at substantially the same temperature as the foodstuff after having flowed around it.

The temperature adjustment is commonly performed by means of heated air that flows around the foodstuff, whereby the temperature of the foodstuff is adjusted. For this purpose, it is for example the case that the air is supplied at a certain temperature corresponding to the desired preheating temperature, whereupon the foodstuff is heated. The heated gas is subsequently usually extracted again in order that further preheated gas can be supplied, wherein this takes place in particular continuously. From the temperature of the discharged gas, that is to say the waste-gas temperature, it is for example possible, given an adequate exchange of heat between gas and foodstuff as the gas flows around the foodstuff, to infer the surface temperature of the foodstuff.

In particular, in the case of the foodstuff subjected to temperature adjustment being treated with water vapor in the vessel, the temperature of the foodstuff can be inferred from the temperature of the extracted water vapor; if the temperature of the extracted water vapor is higher than or equal to the demanded treatment temperature, the time period of the treatment can begin; if the temperature of the extracted water vapor is lower than the demanded treatment temperature, it is for example possible for an erroneous temperature adjustment to be detected, because the temperature of the foodstuff is indeed being adjusted to a preheating temperature higher than or equal to the treatment temperature, that is to say the pasteurization and/or sterilization temperature.

It is thus possible, for example, for the starting time of the treatment in the vessel and/or the time for the conveyance of the foodstuff into the vessel to be determined from the temperature of the discharged gas.

The determination of the temperature of the surface of the foodstuff from the gas surrounding the foodstuff has the advantage that the gas temperature makes it possible to reliably infer the mean surface temperature of the foodstuff, which increases the reliability of the treatment processes in particular with regard to the starting time dependent on the surface temperature. Furthermore, the gas temperature can be reliably determined by means of temperature sensors known to a person skilled in the art, such as for example Pt100 sensors.

It is particularly preferable for the pasteurization and/or sterilization to be started in a manner dependent on a selected preheating temperature and the determined temperature of the surface.

This has the advantage that a preheating temperature can be selected and that, when said preheating temperature is reached, the pasteurization and/or sterilization can be immediately commenced. In this way, the treatment duration is shortened because no additional time is expended for the temperature adjustment. Furthermore, the energy consumption of the apparatus during the execution of the method is reduced.

It is very particularly preferable if the foodstuff is subjected to temperature adjustment in a temperature adjustment device, and after the temperature adjustment, is conveyed into the interior space, and/or the foodstuff is subjected to temperature adjustment in the interior space.

The temperature adjustment of the foodstuff in a temperature adjustment device and the subsequent conveyance of the foodstuff into the interior space has the advantage that the temperature adjustment and the treatment, that is to say pasteurization and/or sterilization, can take place at least partially in parallel, whereby the time for the treatment of multiple batches of foodstuff in succession is reduced.

The temperature adjustment and the treatment, that is to say pasteurization and/or sterilization, of the foodstuff in the interior space have the advantage that a more compact configuration of the apparatus is possible.

The device for charging the interior space with vapor preferably comprises a separation device for separating off liquid from the vapor, wherein liquid is separated off.

This has the advantage that liquid, in particular water, can be separated off from the vapor by means of the separation device. The absorption of liquid, in particular of liquid water constituents in the vapor, by the product is thus substantially prevented, such that the absorption of moisture from the vapor by the foodstuff during the pasteurization and/or sterilization process can be minimized in accordance with the demands on the foodstuff, while pasteurization and/or sterilization is simultaneously realized. Liquid constituents in the vapor normally substantially lead to an increase in the moisture absorption by the foodstuff that is treated with the vapor, but seldomly to more efficient treatment such as for example the pasteurization and/or sterilization.

Such a separation device for separating off liquid from the vapor may for example be designed as a separator. Here, said separator is arranged such that, before the vapor enters the interior space, the liquid can be at least partially separated off by means of the separator.

Liquid separators of said type are known from the prior art and are available for example from the company Spirax Sarco AG under the designation “BZ cyclone separator”, in which the separation is performed by means of centrifugal forces. An alternative vapor separator from the company Spirax Sarco AG under the designation “water separator (vapor dryer) S8”, which is also referred to as an impingement-plate-type separator, achieves a separation action by means of diverting forces that are exerted on the flow.

The device for charging the interior space with vapor preferably comprises a vapor pressure setting device for setting the pressure of the vapor before the vapor enters the interior space, wherein the pressure of the vapor is set substantially to the pressure prevailing in the interior space.

This has the advantage that the vapor can already have the pressure that is preset in the interior space, whereby said vapor also has the desired temperature, because it is indeed preferably saturated steam that is used for the treatment of the foodstuff. The temperature of the saturated steam is normally preferably selected by setting the pressure. By said setting of the pressure of the vapor, a situation is thus advantageously prevented in which the vapor is too hot and disadvantageous intense heating of the foodstuff occurs.

It is particularly preferable for the vapor temperature to be set, before the vapor enters the interior space, by means of a vapor temperature adjustment device.

Within the context of the present application, a “vapor temperature adjustment device” is to be understood to mean a device for setting the vapor temperature. Such a vapor temperature adjustment device may for example be in the form of a heat exchanger.

The setting of the vapor temperature has the advantage that the vapor can be set to the required pasteurization temperature and/or sterilization temperature before it enters the interior space. This is advantageous for example in the case of pasteurization processes that are carried out at negative pressure, in which a temperature in the range from 55° C. to 99° C. is conventional and the vapor may have been generated at a temperature of 100° C. or higher, for example by way of positive pressure. To prevent a further introduction of heat into the foodstuff by the hot vapor, it is advantageous for the temperature of the vapor to be adjusted to the required temperature before it enters the interior space. This leads to improved reproducibility and controllability of the treatment process.

It is preferable for vapor to be extracted from the interior space by means of an extraction device, in particular the pressure setting apparatus. Furthermore, the moisture content of the extracted vapor is reduced by means of a condenser arranged between the extraction device, in particular a pump, and the interior space.

This has the advantage that the moisture is at least partially separated off from the extracted vapor by means of the condenser, whereby the volume flow rate is reduced, and thus only a relatively low-powered extraction device is required during operation, which reduces the energy consumption and reduces the costs for the apparatus.

It is very particularly preferable for condensed liquid to be collected in an intermediate space formed in the interior space between a first slide with at least one opening and a second slide spaced apart from said first slide. The first slide and the second slide are arranged in an outlet region of the vessel for the foodstuff, wherein the second slide is spaced apart from the first slide in the direction in which the foodstuff is conveyed out of the outlet. The first slide, when in a closed position, is in contact with the foodstuff.

In particular, the at least one opening is designed such that, during intended use, substantially no foodstuff can be conveyed through the opening.

This has the advantage that condensed liquid that forms in the interior space can be discharged through the at least one opening of the first slide such that the foodstuff is not in contact with the condensed liquid. This leads to more homogenous treatment of the foodstuff in a manner substantially independent of the fill level in the interior space, because as a result of the discharge of the condensed liquid through the first slide, substantially no foodstuff is in contact with the condensed liquid.

The apparatus normally has an outlet positioned such that, during intended use, the foodstuff, after being treated, is conveyed out of the interior vessel inter alia under the action of gravitational force. Thus, the condensed liquid in the interior space also flows in the direction of the outlet under the action of gravitational force and can thus pass into the intermediate space between the first slide and the second slide through the at least one opening of the first slide. The condensed liquid can then be discharged from said intermediate space when required, for example via an in particular laterally arranged drainage line.

Within the context of the present application, pasteurization is to be understood to mean a treatment of a foodstuff at negative pressure in a temperature range between 55° C. and 99° C.

Within the context of the present application, sterilization is to be understood to mean a treatment of the foodstuff at positive pressure in the range from 100° C. to 140° C.

Pasteurization and/or sterilization is normally performed for a time period of one second to 30 minutes, and preferably of 1 minute to 10 minutes.

A further aspect of the present invention concerns an apparatus for carrying out a method as described above. Said apparatus comprises a vessel with an interior space for accommodating the foodstuff and comprises a device for charging the interior space with vapor, in particular water vapor. Furthermore, the apparatus comprises a temperature adjustment device for adjusting the temperature of the foodstuff to a preheating temperature. The apparatus furthermore has a sensor for determining the temperature of the surface of the foodstuff during the temperature adjustment.

Said apparatus is suitable for carrying out the above-described method, and thus has the advantages described above.

The adjustment of the temperature of the foodstuff takes place for example in a temperature adjustment device, wherein the foodstuff is conveyed into the interior space after the temperature adjustment. It is alternatively also possible for the foodstuff to be subjected to temperature adjustment in the interior space.

With the sensor of the apparatus, there is preferably a control and/or regulation unit for the control and/or regulation of the temperature of the surface of the foodstuff during the temperature adjustment, in particular on the basis of temperature values determined by the sensor. The control and/or regulation unit is in particular in the form of a computer.

This has the advantage that the temperature adjustment can be controlled and/or regulated on the basis of the surface temperature of the foodstuff as measured by means of the sensor. Said control and/or regulation includes for example the setting of the operating variables of temperature, pressure and moisture content, or any desired combinations of these, in the interior space and/or during the temperature adjustment in the temperature adjustment vessel. The operating variables may for example be set as a function of the time.

This has the advantage that flexible and optimal control and/or regulation of the temperature adjustment is made possible.

An additional aspect of the present invention relates to an apparatus for carrying out a method as described above, in particular with the apparatus as described above. Said apparatus comprises a vessel with an interior space for accommodating the foodstuff and comprises a device for charging the interior space with vapor, in particular water vapor. Furthermore, the apparatus comprises a temperature adjustment device for adjusting the temperature of the foodstuff to a preheating temperature. The device for charging the interior space with vapor comprises a separation device for separating off liquid from the vapor.

Said apparatus is suitable for carrying out the method described above, and has the corresponding advantages.

The device for charging the interior space with vapor may for example comprise a vapor pressure setting device, a vapor temperature adjustment device and a separation device for separating off liquid from the vapor.

A further aspect of the present invention concerns an apparatus for carrying out a method as described above, in particular with an apparatus as described above. The apparatus comprises a vessel with an interior space for accommodating the foodstuff and comprises a device for charging the interior space with vapor, in particular water vapor. Furthermore, the apparatus comprises a temperature adjustment device for adjusting the temperature of the foodstuff to a preheating temperature. Furthermore, the apparatus comprises a vapor temperature adjustment device for setting the vapor temperature before the vapor enters the interior space.

The apparatus is suitable for carrying out the method and thus has all of the advantages of the method described above.

An additional aspect of the present invention concerns an apparatus for carrying out a method as described above, in particular by way of an apparatus as described above. The apparatus comprises a vessel with an interior space for accommodating the foodstuff and comprises a device for charging the interior space with vapor, in particular water vapor. Furthermore, the apparatus comprises a temperature adjustment device for adjusting the temperature of the foodstuff to a preheating temperature. In an outlet region of the apparatus, a condensed-liquid discharge device is arranged on and/or in the vessel. The condensed-liquid discharge device comprises a retention device for the foodstuff and at least one opening for the discharge of the condensed liquid into an intermediate space for receiving the condensed liquid.

Said apparatus is suitable for carrying out the method described above and therefore has the corresponding advantages.

In particular, the condensed-liquid discharge device is detachably connected to the vessel. This has the advantage that the condensed-liquid discharge device is exchangeable.

It is preferable in the apparatus for a first slide with at least one opening and a second slide spaced apart from said first slide to be arranged, as a condensed-liquid discharge device, in an outlet region of the vessel for the foodstuff. In particular, the first slide with at least one opening and the second slide spaced apart from said first slide are arranged in the interior space. When the first slide and the second slide are in the closed position, an intermediate space is formed for receiving condensed liquid. The first slide, when in the closed position in a situation of intended use, is in contact with the foodstuff. In other words, the first slide, when in the closed position, is formed as a retention device for the foodstuff.

The condensed-liquid discharge device preferably comprises a valve. The valve is in particular a spherical-segment valve. The valve comprises a closure part, which is designed in particular as a spherical segment. The closure part of the valve, when in the closed position, is in the form of a retention device for the foodstuff. The valve is configured such that, when in the closed position, the at least one opening is formed between a valve housing and the closure part. In particular, the closure part, when in the closed position in a situation of intended use, is in contact with the foodstuff.

The opening may for example be formed by the elimination of a seal between the valve housing and the closure part; if a spherical-segment valve is used, an annular gap may be formed.

The use of a spherical-segment valve in particular has the advantage that the condensed liquid flows to the opening, and can be reliably discharged, owing to the curved surface of the spherical segment facing toward the foodstuff. A particularly reliable discharge of the condensed liquid can be achieved in particular in the case of an elimination of a seal and the formation of an annular opening.

It is preferably possible for the intermediate space for receiving the condensed liquid to be formed by the valve and the second slide. Alternatively, instead of the second slide, use may be made of a shut-off flap, that is to say a butterfly valve.

A further aspect of the present invention concerns an apparatus for carrying out a method as described above, in particular by way of an apparatus as described above. The apparatus comprises a vessel with an interior space for accommodating the foodstuff and comprises a device for charging the interior space with vapor, in particular water vapor. Furthermore, the apparatus comprises a temperature adjustment device for adjusting the temperature of the foodstuff to a preheating temperature. In the interior space of the apparatus, a first slide with at least one opening and a second slide spaced apart from said first slide are arranged in an outlet region of the vessel for the foodstuff. An intermediate space for receiving condensed liquid is formed when the first slide and the second slide are in the closed position. The first slide, when in the closed position in a situation of intended use, is in contact with the foodstuff.

An additional aspect of the present invention concerns an apparatus for carrying out a method as described above, in particular with an apparatus as described above. The apparatus comprises a vessel with an interior space for accommodating the foodstuff and comprises a device for charging the interior space with vapor, in particular water vapor. Furthermore, the apparatus comprises a temperature adjustment device for adjusting the temperature of the foodstuff to a preheating temperature. Furthermore, the apparatus comprises a vapor pressure setting device for setting the pressure of the vapor before the vapor enters the interior space. In particular, the pressure of the vapor can be set, by means of the vapor pressure setting device, to the pressure prevailing in the interior space.

Said apparatus is suitable for carrying out the method described above, and therefore has the corresponding advantages.

A further aspect of the present invention concerns an apparatus for carrying out a method as described above, in particular with an apparatus as described above. The apparatus comprises a vessel with an interior space for accommodating the foodstuff and comprises a device for charging the interior space with vapor, in particular water vapor. Furthermore, the apparatus comprises a temperature adjustment device for adjusting the temperature of the foodstuff to a preheating temperature. Furthermore, the apparatus comprises an extraction device for the extraction of vapor, said extraction device being connected in terms of flow to the interior space. In particular, the extraction device is in the form of a pressure setting apparatus. Between the extraction device, in particular a pump for the extraction of gas, and the interior space there is arranged a condenser for condensing liquid out of the extracted vapor, in particular the water out of the water vapor.

This leads in particular to a reduction in the flow rate and the volume of the extracted vapor, whereby the volume flow rate is reduced and thus only a relatively low-powered extraction device is required during operation, which reduces the energy consumption and reduces the costs for the apparatus.

Said apparatus is suitable for carrying out the method described above and therefore has the corresponding advantages.

The apparatus as described above is preferably suitable for carrying out a method as described above, wherein the apparatus has a temperature adjustment device and at least two vessels, wherein a foodstuff can be subjected to temperature adjustment by means of the temperature adjustment device and can be conveyed into the two vessels two vessels sequentially and/or in parallel by means of a conveying device.

In other words, it is thus possible by means of the conveying device for a foodstuff to be conveyed simultaneously, that is to say in parallel, into both vessels or to be conveyed sequentially into the first and then into the second of the two vessels, in particular in a manner dependent on a signal.

This has the advantage that the treatment of the foodstuff can be performed on a quasi-continuous basis, and the throughput through the apparatus can be increased.

Here, the conveying device may for example be in the form of a worm-type conveyor with a controllable flap system for conveyance into the selected vessel. Alternatively, use may also be made of a vibroconveyor, a chute, a pendulum-bucket conveyor, a tube chain conveyor or some other suitable conveying device with the controllable flap system.

The invention will be explained in more detail below on the basis of exemplary embodiments for improved understanding, without the invention being restricted to these exemplary embodiments. In the drawing:

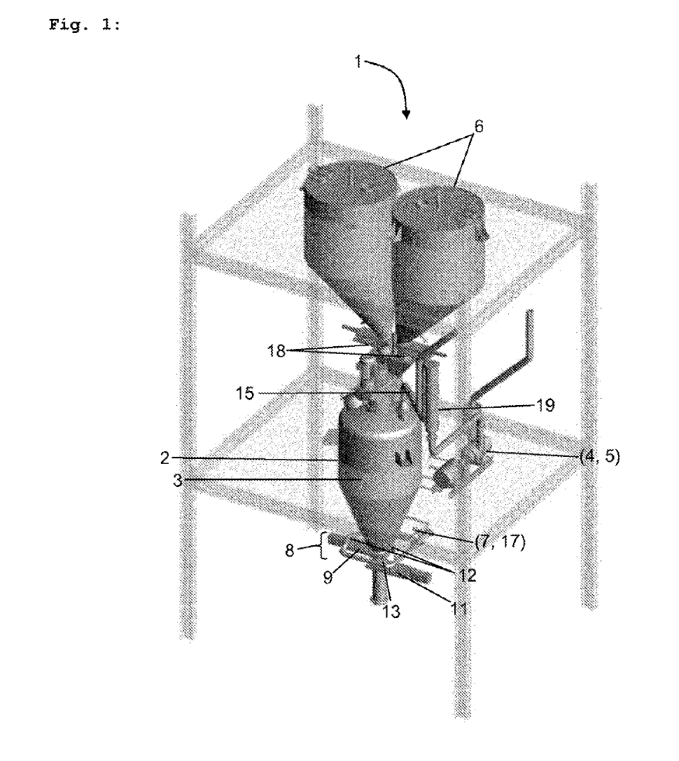

FIG. 1 is a perspective illustration of an apparatus according to the invention with vessel and upstream batch vessel;

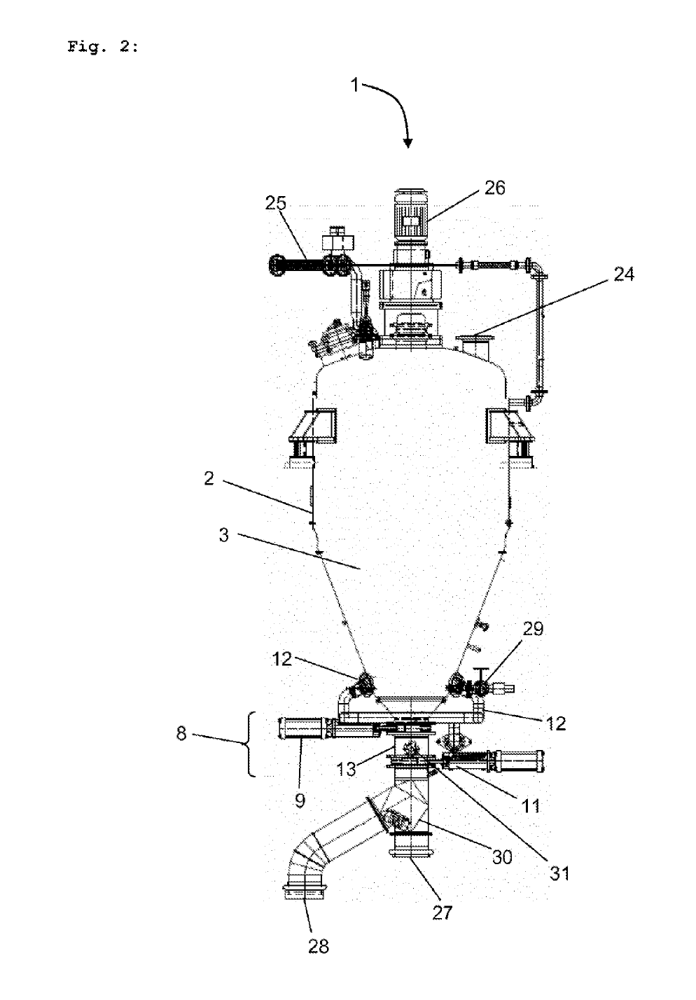

FIG. 2 is a detailed illustration of a vessel according to the invention as illustrated in FIG. 1;

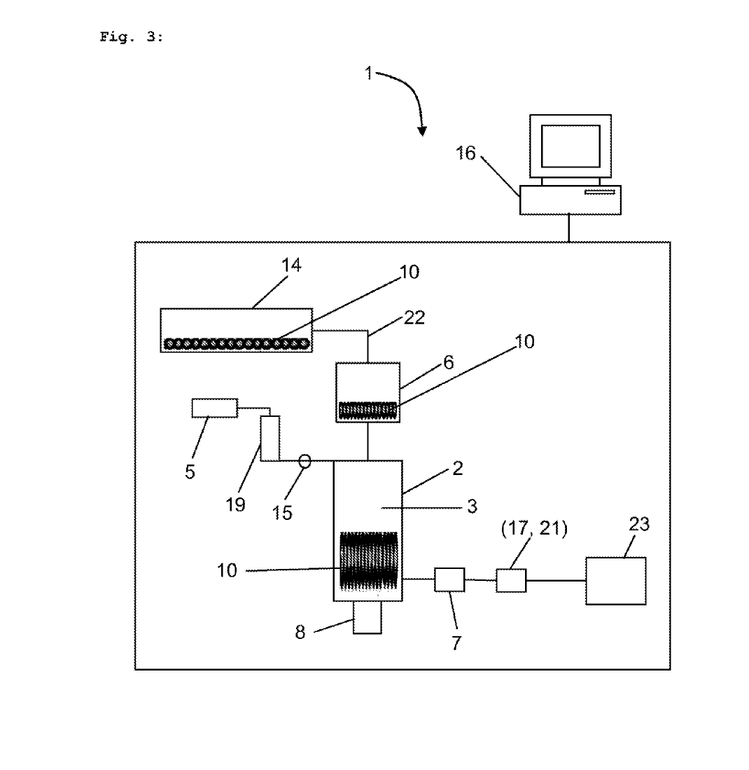

FIG. 3 is a schematic illustration of an alternative apparatus according to the invention;

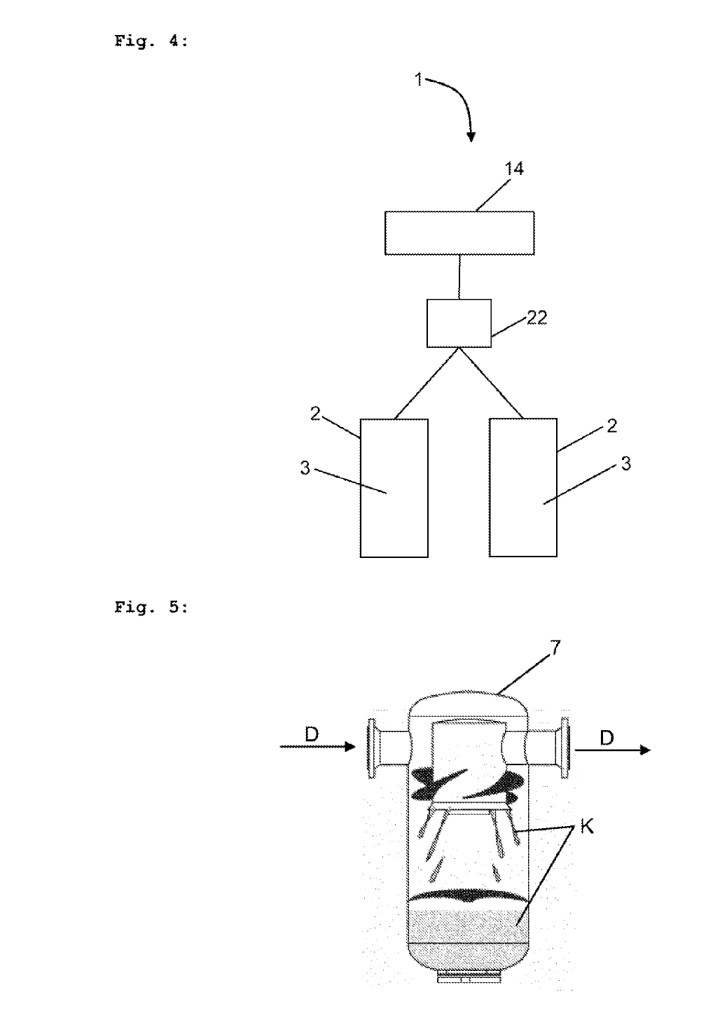

FIG. 4 is a schematic illustration of a further alternative apparatus according to the invention;

FIG. 5 is a schematic illustration of a liquid separator;

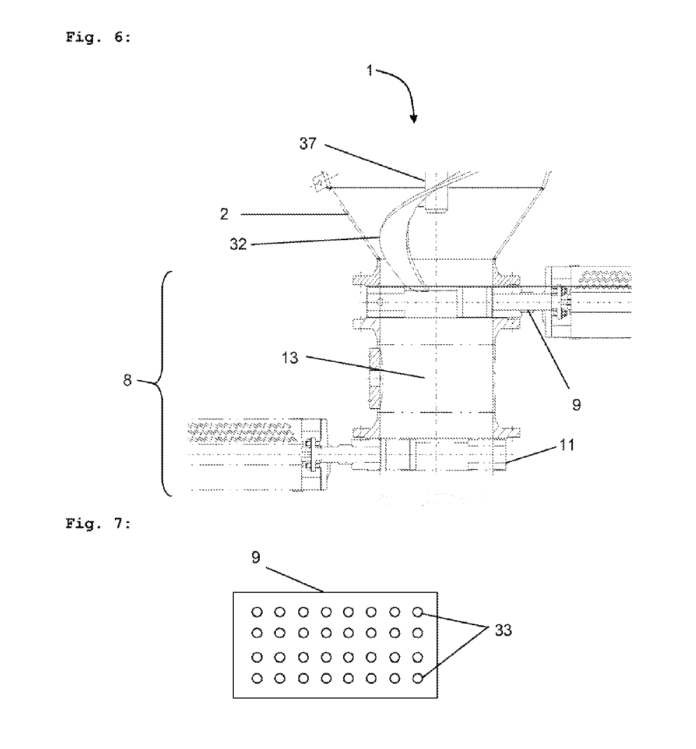

FIG. 6 is an enlarged illustration of the outlet region as per FIG. 2;

FIG. 7 shows a plan view of a first slide according to the invention in a schematic illustration;

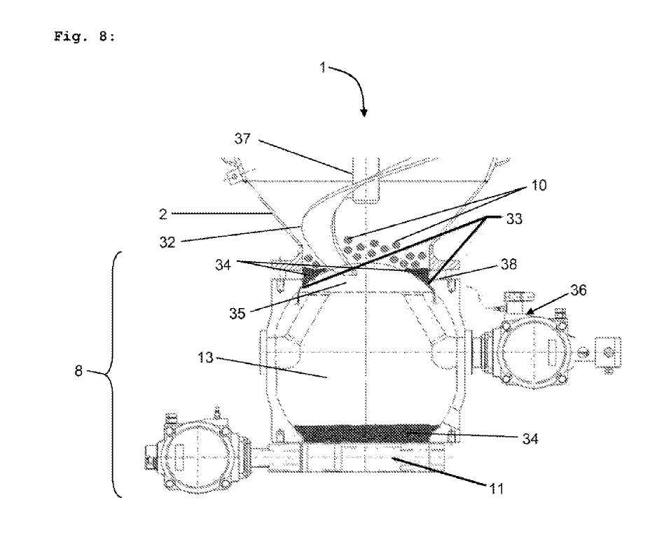

FIG. 8 shows a side view of the outlet region of an alternative condensed-liquid discharge device according to the invention.

FIG. 1 illustrates an apparatus 1 for the pasteurization and/or sterilization of a foodstuff for carrying out the method according to the invention. A foodstuff is conveyed into the two batch vessels 6, for which purpose the cover of the batch vessels 6 is opened. Said batch vessels 6 can be subjected to temperature adjustment by means of temperature adjustment devices 14, which in this case are in the form of electrical heating devices, arranged in the side walls. In this way, it is possible for a foodstuff which has for example been subjected to temperature pre-adjustment to be kept at the corresponding temperature in the batch vessel 6. When the vessel 2 is ready to receive the foodstuff that has been subjected to temperature adjustment, the foodstuff is conveyed into an interior space 3 of the vessel 2, for which purpose feed slides 18 are opened.

The vessel 2 is in the form of a double-walled vessel, wherein vapor and/or hot water can be fed into the double wall for the purpose of further temperature adjustment of the foodstuff in the interior space 3 of the vessel 2.

The apparatus 1 has a vapor supply device 12 in which there is arranged a moisture content setting device 7, which in this case is in the form of a vapor dryer. Also arranged in the vapor supply device 12 is a vapor temperature adjustment device 17 which is in the form of a heat exchanger for the purpose of cooling the vapor.

Furthermore, the apparatus 1 has a pressure setting apparatus 4 which, in this case, is in the form of a pump 5 for the extraction of gas. A negative pressure can be generated in the vessel by means of said pump 5. Furthermore, a condenser 19 in tube form is arranged in the pressure setting apparatus 4 for the purpose of reducing the moisture content of the extracted gas, whereby the volume flow rate in the pressure setting apparatus 4 is reduced.

A first slide 9, which is in the form of a perforated plate, and a second slide 11 are arranged in an outlet region 8 of the vessel 2. An intermediate space 13 is formed between the first slide 9 and the second slide 11. During operation, condensed liquid which is formed in the interior space 3 and which flows in the direction of the first slide under the action of gravity during intended use can pass through the perforated plate of the first slide 9 into the intermediate space 13. Since the foodstuff cannot pass through the perforated plate of the first slide 9, the condensed liquid is thus removed from the interior space 3 of the vessel 2, such that the foodstuff situated adjacent to the outlet region 8 cannot absorb an excessive amount of water, and thus the most homogenous possible treatment of the foodstuff in the interior space 3 of the vessel 2 is achieved.

In the pressure setting apparatus 4 there is arranged a sensor 15 for temperature measurement, by means of which sensor the temperature of the extracted gas can be measured for the purpose of determining the surface temperature of the foodstuff in the interior space 3.

FIG. 2 shows a detailed illustration of a vessel 2 such as is used in the apparatus 1 as per FIG. 1.

The vessel 2 has an interior space 3 with a mixing element (not illustrated here) for circulating the foodstuff in the interior of the vessel during the treatment process, that is to say during the pasteurization and/or sterilization of the foodstuff. Said mixing element is driven by means of a drive 26 in the form of an electric motor.

The foodstuff is conveyed through the foodstuff inlet 24 into the interior space of the vessel 2 by means of a conveying device which is not illustrated here.

During operation, water vapor is conveyed into the interior space 3 of the vessel 2 by means of the vapor supply device 12, wherein the vapor supply device 12 comprises a valve 29 for the control and/or regulation of the vapor supply as a function of the demands of the treatment process. The supplied water vapor can be discharged by means of the vapor outlet 25.

In an outlet region 8 of the apparatus 1 there are arranged a first slide 9 and a second slide 11, between which there is formed an intermediate space 13. The first slide 9 is in the form of a perforated plate as described with regard to FIG. 1. A condensate drainage line 31 is provided for the discharge of condensed liquid, for example condensed water, that has collected in the intermediate space 13. When the second slide is closed, that is to say for example during the treatment of the foodstuff, the condensed liquid can be discharged through the condensate drainage line 31, specifically in such a way that a negative pressure or else a positive pressure is maintained in the interior space 3 of the vessel 2.

For the drainage of condensed liquid that has not been discharged via the condensate drainage line 31, the second slide 11 is opened after the treatment of the foodstuff, whereby the condensed liquid can flow out through the liquid outlet 28. For this purpose, a switchover flap 30 may be positioned such that condensed liquid can flow out through the liquid outlet 28. After the drainage of the condensed liquid, the switchover flap 30 is positioned such that the foodstuff can be conveyed from the vessel 2 out of the apparatus 1 through the foodstuff outlet 27.

The same reference signs will hereinafter be used to denote identical components in the figures.

FIG. 3 illustrates an alternative apparatus 1 according to the invention in a schematic illustration.

A foodstuff 10, which in the present case is almonds, is subjected to temperature adjustment to a temperature of 85° C. by means of a temperature adjustment device 14. The temperature adjustment device 14 is, in the present case, a device which can be operated continuously and which has a conveyor belt and a hot-air supply, whereby the temperature of the foodstuff 10 is adjusted to a temperature of 85° C. by means of the temperature adjustment device 14.

The foodstuff 10 that has been subjected to temperature adjustment is conveyed into the batch vessel 6 by means of a conveying device 22, which in this case is in the form of a vibrating trough. In the present case, the batch vessel 6 does not have a temperature adjustment device as described in FIG. 1, but is insulated with respect to the environment such that the temperature can be maintained for an adequately long period of time.

Subsequently, when the vessel 2 is ready for receiving the foodstuff 10 from the batch vessel 6, the foodstuff 10 that has been subjected to temperature adjustment is conveyed into the interior space 3 of the vessel 2.

By means of the pump 5, a negative pressure of 0.5 bar absolute pressure is generated in the interior space of the vessel 2. Furthermore, water vapor is generated by means of the vapor generator 23. This may be performed for example by means of a heating device by means of which water is evaporated, wherein, in the present case, the vapor has a pressure of 1.5 bar absolute pressure.

The vapor is subsequently conveyed into a vapor pressure setting device 21 in which the pressure of the water vapor is reduced to a pressure of 0.5 bar, as has also been set in the interior space 3 by means of the pump 5. Owing to the reduction of the pressure, the evaporation temperature is reduced to approximately 81° C. Owing to the pressure reduction, superheated vapor is obtained, for which reason the superheat is discharged in a vapor temperature adjustment device 17 such that the temperature of the vapor corresponds substantially to the evaporation temperature, that is to say saturated steam is present.

By means of the temperature sensor 15, the waste-gas temperature can be determined in order to determine the preferred start of the supply of water vapor for the pasteurization process.

After the setting of the pressure of the water vapor in the pressure setting device 21 and the treatment in the vapor temperature adjustment device 17, the water vapor is conveyed into the separation device 7 for separating off water from the water vapor, such that the vapor contains substantially no liquid water. The water vapor is thereupon conveyed, in a manner dependent on the signal of the temperature sensor 15, into the interior space 3 of the vessel 2, whereby the foodstuff 10, which is at a temperature of approximately 85° C., is pasteurized.

In a condenser 19, moisture is separated off from the extracted water vapor in order to reduce the volume flow rate in the pump 5.

Following the pasteurization of the foodstuff 10, the pasteurized foodstuff 10 is conveyed from the interior space 3 out of the apparatus through the outlet region 8. In the present case, by contrast to FIG. 1, no first slide and second slide are arranged in the outlet region 8.

For the control and/or regulation of the method for pasteurization and/or sterilization, the apparatus 1 described above is connected to a control and/or regulation unit 16, which in this case is in the form of a computer.

FIG. 4 schematically illustrates a further alternative embodiment of the present invention.

The apparatus 1 comprises a temperature adjustment device 14 as described with regard to FIG. 3 and also a conveying device 22, which is in the form of a worm-type conveyor. A foodstuff is subjected to temperature adjustment to a first temperature by means of the temperature adjustment device and is conveyed into one of the two vessels 2 by means of the conveying device 22. The two vessels 2 are in each case as illustrated in FIG. 2.

The conveying device 22 comprises a flap system (not illustrated) by means of which it is made possible for one or the other vessel 2 to be filled by means of the conveying device 22 in a manner dependent on the state of readiness of the two vessels 2. In this way, during operation, it is made possible for a foodstuff to continuously be subjected to temperature adjustment by means of the temperature adjustment device 14 and subsequently conveyed into one of the two vessels 2 by means of the conveying device 22. This is achieved in that, in a first step, a first of the two vessels 2 is filled with foodstuff by means of the conveying device 22, whereupon the pasteurization can be performed in said vessel 2. During the pasteurization in the first of the two vessels 2, it is then possible for the second vessel 2 to be filled with foodstuff by means of the conveying device 22. It is thus possible to achieve quasi-continuous operation despite the batch-wise processing in the vessels 2.

FIG. 4 does not illustrate the devices for vapor supply and vapor discharge.

FIG. 5 shows a BZ cyclone liquid separator from the company Spirax Sarco AG. Vapor D is produced in a vapor generator (not shown here) and conveyed into the separation device 7. In the separation device 7, condensed liquid K, which in the present case is water, is separated off and collected. The vapor D which has been dried in the separation device 7 is subsequently conveyed out of the separation device 7 and conveyed for example into a vessel (not illustrated here).

FIG. 6 is an enlarged illustration of the outlet region 8 as per FIG. 2. The outlet region 8 is detachably connected to the vessel 2. During the treatment of a batch of a foodstuff in the vessel 2, the foodstuff can be mixed and/or rearranged by means of the mixing element 32. For this purpose, the mixing element 32 is arranged on a shaft 37 which is mounted so as to be rotatable and which can be driven by means of the drive from FIG. 2. Furthermore, by means of the mixing element 32, the conveyance of the foodstuff out of the vessel 2 after the pasteurization and/or sterilization process can be improved.

During the treatment of the foodstuff in the vessel 2, the first slide 9 and the second slide 11 are closed so as to form the intermediate space 13. The first slide 9 and the second slide 11 are designed such that substantially the same pressure prevails in the intermediate space 13 as in the vessel 2; if a positive pressure or a negative pressure is generated in the vessel 2, the intermediate space 13 has substantially the same pressure as the vessel 2.

The first slide 9 is in the form of a perforated slide with openings 33, as illustrated in FIG. 7. The openings 33 are dimensioned such that the foodstuff is retained in the vessel and the condensed liquid can flow into the intermediate space.

FIG. 8 illustrates, in a side view, an outlet region 8 of an alternative condensed-liquid discharge device according to the invention.

The condensed-liquid discharge device comprises a spherical-segment valve 36 with a spherical segment 35. The spherical segment 35 of the spherical-segment valve 36 is in the form of a retention device for a foodstuff 10. The spherical-segment valve 36 also comprises a valve housing 38. The spherical segment 35 and the valve housing 38 are designed such that, in the closed position, an opening 33 is formed between the valve housing 38 and the spherical segment 35.

The opening 33 is, as an annular opening 33, formed by the elimination of a sealing element between the spherical segment 35 and the valve housing 38, as in the case of conventional spherical-segment valves. In this way, condensed liquid 34 can flow out of the vessel 2 into the intermediate space 13, whereas the foodstuff 10 is retained in the vessel 2 by the spherical segment 35.

The second slide 11 for forming the intermediate space 13 with the spherical-segment valve 36 is in the form of a shut-off flap. Shut-off flaps are also referred to as butterfly valves.

1-22. (canceled)

23. A method for the pasteurization and/or sterilization of a foodstuff comprising the following steps:
providing an apparatus for the impingement of vapor on the foodstuff, the apparatus comprising in particular a vessel with an interior space for accommodating the foodstuff and with a device for charging the interior space with vapor,
causing the foodstuff to be impinged on with vapor,
pasteurizing and/or sterilizing the foodstuff by means of the vapor in order to achieve a reduction in the quantity of a microorganism present on and/or in the foodstuff, wherein
the temperature of the foodstuff is adjusted to a preheating temperature, which is higher than or equal to the pasteurization and/or sterilization temperature, before the impingement with vapor.

24. The method as claimed in claim 23, wherein the apparatus is provided comprising a pressure setting apparatus for setting a positive pressure and/or negative pressure in the interior space, and setting the pressure in the interior space by means of the pressure setting apparatus.

25. The method as claimed in claim 23, wherein the foodstuff is dried.

26. The method as claimed in claim 25 wherein the foodstuff is vacuum dried.

27. The method as claimed in claim 23, wherein the temperature of the surface of the foodstuff is determined by means of a sensor during the temperature adjustment.

28. The method as claimed in claim 27, wherein the temperature of the surface of the foodstuff is determined from the temperature of the gas, that surrounds the foodstuff during the temperature adjustment.

29. The method as claimed in claim 28, wherein the temperature of the surface of the foodstuff is determined from the temperature of the gas that is extracted from the vessel and/or from a temperature adjustment device by means of a pump.

30. The method as claimed in claim 27, wherein the pasteurization and/or sterilization is started in a manner dependent on a selected preheating temperature and the determined temperature of the surface.

31. The method as claimed in claim 23, wherein the foodstuff is subjected to temperature adjustment in the temperature adjustment device, and after the temperature adjustment, is conveyed into the interior space, and/or in that the foodstuff is subjected to temperature adjustment in the interior space.

32. The method as claimed in claim 23, wherein the device for charging the interior space with vapor comprises a separation device for separating off liquid from the vapor, and liquid is separated off.

33. The method as claimed in claim 23, wherein the device for charging the interior space with vapor comprises a vapor pressure setting device for setting the pressure of the vapor before the vapor enters the interior space, and the pressure of the vapor is set substantially to the pressure prevailing in the interior space.

34. The method as claimed in claim 23, wherein the vapor temperature is set, before the vapor enters the interior space, by means of a vapor temperature adjustment device.

35. The method as claimed in claim 23, wherein vapor is extracted from the interior space by means of an extraction device, and the liquid fraction is reduced in the extracted vapor by means of a condenser which is arranged between the extraction device and the interior space.

36. The method as claimed in claim 23, wherein condensed liquid is collected in an intermediate space formed in the interior space between a first slide with at least one opening and a second slide spaced apart from said first slide, wherein the first slide and the second slide are arranged in an outlet region of the vessel for the foodstuff, and in a closed position, the first slide is in contact with the foodstuff.

37. An apparatus for carrying out a method as claimed in claim 23, comprising a vessel with an interior space for accommodating the foodstuff and with a device for charging the interior space with vapor and with a temperature adjustment device for adjusting the temperature of the foodstuff to a preheating temperature, wherein the apparatus has a sensor for determining the temperature of the surface of the foodstuff during the temperature adjustment.

38. The apparatus as claimed in claim 37, wherein a control and/or regulation unit is connected to the sensor and serves for the control and/or regulation of the temperature of the surface of the foodstuff during the temperature adjustment.

39. The apparatus as claimed in claim 38, wherein a control and/or regulation unit serves for the control and/or regulation of the temperature of the surface of the foodstuff during the temperature adjustment on the basis of temperature values determined by the sensor.

40. An apparatus for carrying out a method as claimed in claim 23, comprising a vessel with an interior space for accommodating the foodstuff and with a device for charging the interior space with vapor and with a temperature adjustment device for adjusting the temperature of the foodstuff to a preheating temperature, wherein the device for charging the interior space with vapor comprises a separation device for separating off liquid from the vapor.

41. An apparatus for carrying out a method as claimed in claim 23, comprising a vessel with an interior space for accommodating the foodstuff and with a device for charging the interior space with vapor, and with a temperature adjustment device for adjusting the temperature of the foodstuff to a preheating temperature, wherein the apparatus comprises a vapor temperature adjustment device for setting the vapor temperature before the vapor enters the interior space.

42. An apparatus for carrying out a method as claimed in claim 23, comprising a vessel with an interior space for accommodating the foodstuff and with a device for charging the interior space with vapor, and with a temperature adjustment device for adjusting the temperature of the foodstuff to a preheating temperature, wherein the apparatus comprises a vapor pressure setting device for setting the pressure of the vapor before the vapor enters the interior space,

43. An apparatus for carrying out a method as claimed in claim 42, wherein said pressure is adjustable to the pressure prevailing in the interior space.

44. An apparatus for carrying out a method as claimed in claim 23, comprising a vessel with an interior space for accommodating the foodstuff and with a device for charging the interior space with vapor and with a temperature adjustment device for adjusting the temperature of the foodstuff to a preheating temperature, wherein a condensed-liquid discharge device is arranged on and/or in the vessel in an outlet region of the apparatus, wherein the condensed-liquid discharge device comprises a retention device for the foodstuff and at least one opening for the discharge of the condensed liquid into an intermediate space for receiving the condensation liquid.

45. The apparatus as claimed in claim 44, wherein a first slide with at least one opening and a second slide spaced apart from said first slide are arranged, as a condensed-liquid discharge device, in the outlet region of the vessel for the foodstuff, wherein the intermediate space for receiving condensed liquid is formed when the first slide and the second slide are in the closed position, and wherein the first slide, when in the closed position in a situation of intended use, is in contact with the foodstuff.

46. The apparatus as claimed in claim 44, wherein the condensed-liquid discharge device comprises a valve having a closure part, wherein the closure part of the valve, when in the closed position, is in the form of a retention device for the foodstuff, and wherein the valve is configured such that, when in the closed position, the at least one opening is formed between a valve housing and the closure part.

47. An apparatus for carrying out a method as claimed in claim 23, comprising a vessel with an interior space for accommodating the foodstuff and with a device for charging the interior space with vapor and with a temperature adjustment device for adjusting the temperature of the foodstuff to a preheating temperature, wherein an extraction device for the extraction of vapor is connected in terms of flow to the interior space, and a condenser for reducing the liquid fraction of the extracted vapor is arranged between the extraction device and the interior space.

48. The apparatus as claimed claim 37, wherein the apparatus has a temperature adjustment device and at least two vessels, wherein a foodstuff can be subjected to temperature adjustment by means of the temperature adjustment device and can be conveyed into the two vessels sequentially and/or in parallel by means of a conveying device.
